(19) United States
(12) Patent Application Publication
(10) Pub. No.: US 2002/0134438 A1
(43) Pub. Date: Sep. 26, 2002

(54) Viewing device adaptable to a pipe in which fluids containing solid particles circulate

(76) Inventors: Regis Vilagines, Vienne (FR); Philippe Maurel, Sainte-Foy-Les-Lyons (FR); Yvon Lagrange, (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/879,101

(22) Filed: Jun. 13, 2001

(30) Foreign Application Priority Data
Jun. 13, 2000 (FR) 00/07597

(51) Int. Cl. F16K 49/00

(52) U.S. Cl. 137/559; 137/341

(57) ABSTRACT

Viewing device adaptable to a pipe in which a fluid containing solid particles circulates, allowing to examine a volume of this fluid isolated from the fluid stream without changing its thermodynamic state in relation to that of the circulating fluid.

It comprises a ball valve (1) provided with a central passage (12), which is interposed between two sections (9A, 9B) of the pipe, and means for swivelling the ball valve between a first position where central passage (12) communicates the two sections (9A, 9B) of the pipe on either side of valve (1) and a second position where the volume of fluid in central passage (12) is isolated from the pipe and communicates with at least one lateral viewing or observation chamber (11A, 11R) closed by a porthole (10) for example, a pressure balancing set (15-18, V) and a device (20-22) intended for thermoregulation of the isolated volume of fluid in lateral chamber(s) (53, 54) in order to maintain it in the same thermodynamic state as the fluids in the pipe. The device allows to view particle deposits and to examine the state of the walls.

Applications: oil production, fluid supply networks, etc.

### FIELD OF THE INVENTION

The present invention relates to a device for viewing deposits and/or solids suspended in a fluid.

The device according to the invention finds applications in many industrial sectors, notably for monitoring fluids circulating in pipes that carry particles likely to undergo a change of state when the thermodynamic conditions vary. This is for example the case for paraffin crystals or hydrates (solid particles appearing in pipes under pressure in the presence of water and hydrocarbons) contained in the fluids conveyed in oil lines, whose state greatly depends on the ambient temperature and pressure conditions. When conveyed through colder zones or if the circulation of the fluids is momentarily interrupted, the paraffins or hydrates are likely to crystallize upon getting colder and to settle down, which modifies the flow conditions and might even clog the pipes.

The viewing device according to the invention can also be used in water supply networks to monitor the formation of scale also likely to clog the pipes.

The device according to the invention allows to periodically examine pipes and to apply in due time preventive treatments in order to remove the deposits and to avoid the heavy mechanical operations of periodic dismantling (disadvantegous to tightness) that are commonly carried out therefore.

### BACKGROUND OF THE INVENTION

Patent DE 38 16 736 describes a device for controlling clogging of a filter used in airplane refuelling systems. The valve is mounted on a fuel circulation pipe and comprises a viewing way. A porthole arranged in the vicinity of the viewing way allows to check the state of a filter arranged near the valve. The valve can be swivelled from a circulation position where the fuel flows through the filter to a viewing position where the filter is in line with the porthole. The state of the filter can thus be readily controlled and it can be changed in due time.

### SUMMARY OF THE INVENTION

The viewing device according to the invention is adaptable to a pipe in which fluids containing solid particles circulate, and it allows to examine a volume of fluid isolated from the fluid stream, as well as the inner walls of the device, without changing its thermodynamic state in relation to that of the circulating fluid. It comprises a ball valve provided with a central passage, which is interposed between two sections of the pipe, and means for swivelling the ball valve from a first position where the central passage communicates the two sections of the pipe on either side of the valve to a second position where the volume of fluid in the central passage is isolated from the pipe and communicates with at least one lateral viewing or observation chamber. It also comprises balancing means for maintaining said volume of fluid substantially in the same thermodynamic state as the fluids in the pipe, in the second position of the ball valve.

The balancing means comprise for example a pressure balancing set and an insulating lagging or a fluid thermoregulation device in each lateral chamber intended to maintain the fluids at a substantially constant temperature equal to that prevailing in the pipe sections.

The pressure balancing set comprises for example at least one circuit associated with control valves, this circuit communicating with a pipe section and at least one lateral viewing chamber by means of an automatic pressure balancing means such as a membrane accumulator containing an inert gas, intended to maintain the pipe and said lateral viewing chamber under equipressure.

The temperature regulation device comprises for example circuits intended to circulate a heat carrier around at least one lateral chamber (in a coil wound around each chamber or in a double wall), or an electric thermostat-controlled heating circuit for example.

The device advantageously comprises a ring for lining the inner passage in the ball, made from the same material as the inner walls of the pipe sections so that the deposits formed thereon are really representative of those formed on the walls of the pipe sections.

The viewing device also comprises for example a pipe provided with a bleed valve connected with at least one lateral viewing chamber for draining the fluid trapped in the ball and each lateral viewing chamber.

The viewing device also comprises for example an injection circuit communicating with at least one lateral viewing chamber and allowing injection of products into the fluid trapped in the ball of the valve and in each viewing chamber. The products injected can be, for example, additives whose efficiency can be advantageously observed, or products for washing the fluid trapped in the viewing volume and for cleaning the walls and the inner face of the viewing portholes.

The viewing device can also comprise at least one lighting device for lighting the inside of each lateral viewing chamber and of the passage and/or device for measuring physical parameters of the fluids and of the particles: optical detectors, ionizing particle detectors, etc., according to the nature of the particles carried by the fluids, for measuring their density for example.

The ball valve is for example a four-way valve, two ways communicating respectively with the sections of the pipe on either side of the body of the ball valve, two other ways forming the two lateral chambers and being delimited by walls allowing observation.

The device is advantageous because it allows, with great ease of operation, to observe the fluids transported and to measure the thickness of the deposits formed in the pipes, under the same thermodynamic conditions as those prevailing therein, without requiring circulation interruptions. A change in the aspect of the deposited substances or in the volume thereof, that would be caused by a pressure drop, is thus prevented. This quick examination of the walls also allows to prevent corrosion phenomena more efficiently. The device facilitates diagnosis and allows to test the efficiency of the possible solutions for overcoming deposition: selected additives for preventing deposition, selection of wall coating, etc.

The device can be interposed for example on pipes in which circulate hydrocarbons containing various solid particles: paraffins or hydrates in the process of crystallizing, etc., as a result of temperature and pressure conditions variations during transport.

It is also possible to place suitable measuring devices before the lateral chambers.

The device can find many applications in all sorts of industrial facilities or supply networks.

### BRIEF DESCRIPTION OF THE DRAWINGS

Other features and advantages of the device according to the invention will be clear from reading the description of embodiments given hereafter by way of non limitative example, with reference to the accompanying drawings wherein:

FIG. 1 diagrammatically shows a cross-section of the viewing device according to the invention in circulation position, and

FIG. 2 shows the device of FIG. 1 in viewing position.

### DETAILED DESCRIPTION

The viewing or observation device according to the invention is made using for example a ball valve 1 interposed on a pipe in which fluids containing solid particles in suspension and likely to settle on the walls circulate. Valve 1 comprises a body 2 with an inner cavity for a ball 3, which communicates with the outside by means of four openings 4 opposite two by two. Four connecting sleeves 51, 52, 53, 54 are associated with this valve body. Each sleeve comprises a mounting flange 6 against the valve body and a tubular extension 7 intended to fit into an opening 4. At the opposite end thereof, each connecting sleeve 51-54 comprises a second mounting flange 8. Two parts 9A, 9B of a pipe in which the fluids circulate are fastened to the flanges 8 of two opposite connecting sleeves 51, 52. Transparent portholes 10 are fastened against the flanges 8 of the other two connecting sleeves 53, 54 delimiting two lateral chambers 11A, 11B.

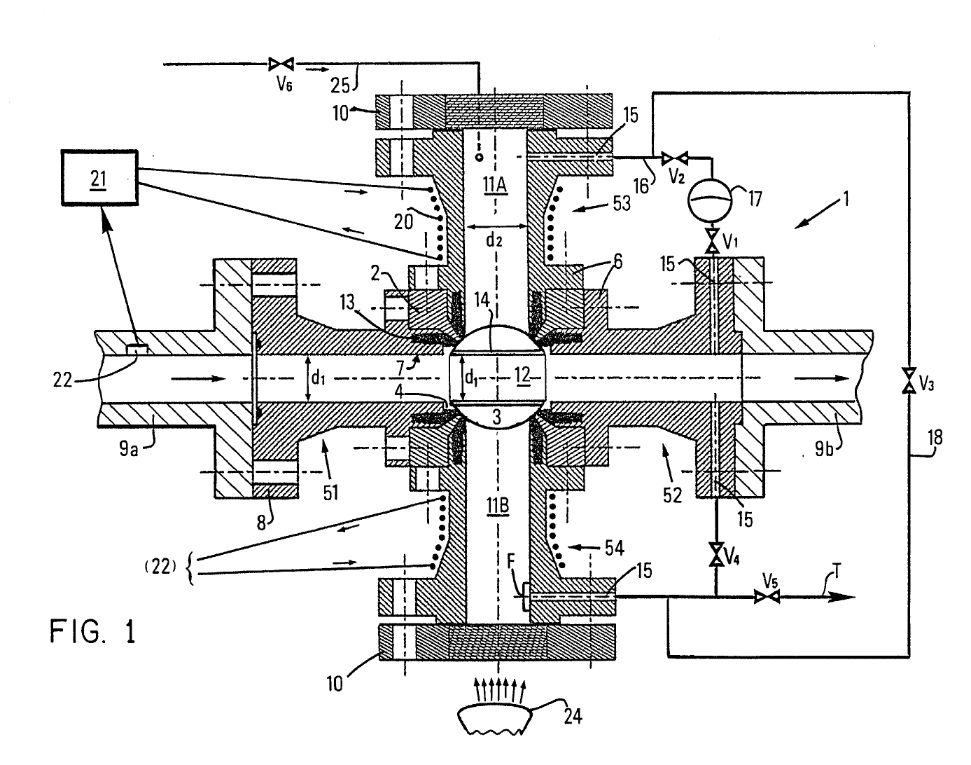

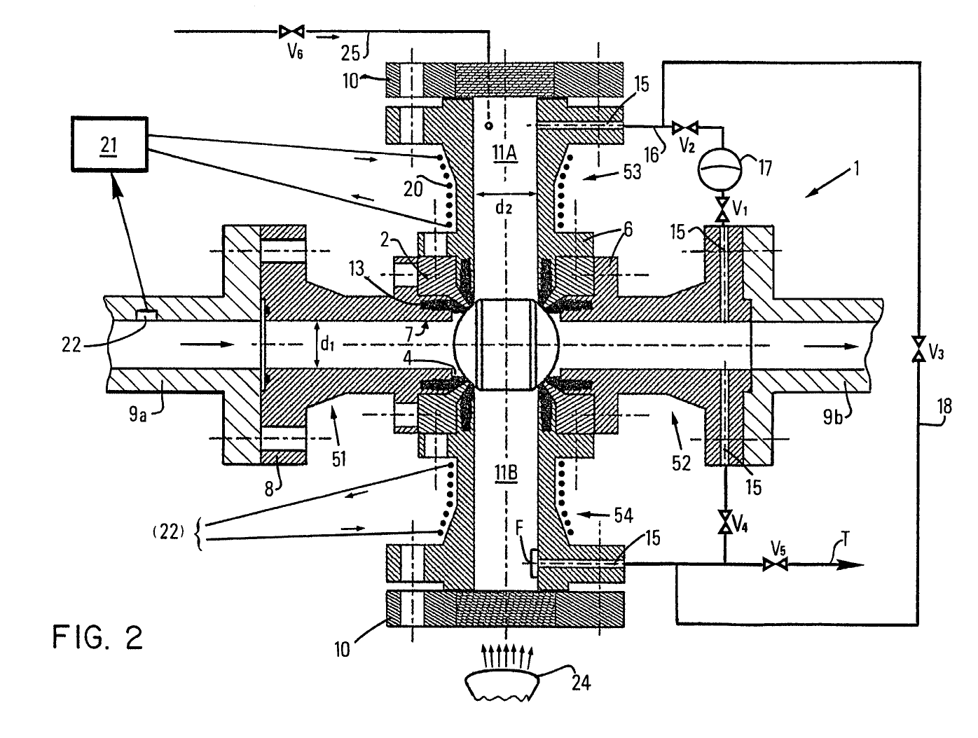

Ball 3 is provided with a central passage 12. It can swivel between a first position (FIG. 1) where parts 9A, 9B of the section directly communicate with each other by means of central passage 12 and a second position (FIG. 2), with an angular displacement in relation to the first position (90° for example), where central passage 12 communicates the two lateral viewing chambers 11A, 11B.

The diameter of central passage 12 of ball 3 is for example equal to the inside diameter d₁ of pipe sections 9A, 9B. It is preferably less than the diameter d₂ of lateral chambers 11A, 11B so as to facilitate visual examination of the walls thereof. Seals 13 are arranged in tubular extensions 7 in order to isolate from one another the inner spaces of the four sleeves 51-54 when ball 3 is in the first or in the second position.

Central passage 12 is preferably reamed to a greater diameter than the inner section of connecting sleeves 51, 52 and of the connected pipe sections, and a ring 14 having the same inner section as sleeves 51, 52 is added in this bore. This ring 14 is made from the same metal as pipe sections 9A, 9B; its corrosion or deposition state is thus really representative of that of the pipe sections.

Diameter d₁ of the central passage in the ball is preferably selected to provide the continuity of the sealed insulation between lateral chambers 11A, 11B and pipe sections 9A, 9B when ball 3 switches from the viewing position into the circulation position.

For example, diameter d₁ of this central passage is so selected that

$$Arcsin ( \frac{{d}_{1}}{D} ) < \frac{π}{n}$$

where D is the diameter of the ball and n the number of viewing and circulation chambers, and preferably so that

$$Arcsin ( \frac{{d}_{1}}{D} ) \leq \frac{3 π}{4 n} .$$

Ball 3 of the valve is of course associated with a conventional operating means (not shown) allowing to swivel it from the circulation position to the viewing position and conversely.

### Pressure Control and Maintenance

In the case of a four-way device as shown in FIGS. 1 and 2 for example, a channel is pierced throughout the thickness of the wall of at least three connecting sleeves (sleeves 52, 53, 54 for example). The channels 15 of connecting sleeves 52, 53 for example are connected by pressure balancing means comprising for example a circuit 16 on which are interposed a membrane accumulator 17 containing an inert gas at a pressure substantially equal to that of the circulating fluid and two isolating valves V1, V2. Another circuit 18 associated with a valve V3 also communicates channels 15 of sleeves 53, 54 so that their pressures can be balanced. A bleed circuit T controlled by a bleed valve V5 is arranged at a lower point of lower lateral chamber 11B.

Valve V4 allows to directly communicate lateral viewing chambers 11A and 11B with the inside of one of the sleeves of the circulation way (sleeve 52 in the present case) when it is open.

When the device is in the circulation position diagrammatically shown in FIG. 1, the volume consisting of the two lateral chambers 11A and 11B is for example filled with the inert gas coming from membrane accumulator 17 and maintained thereby at the pressure of the fluid stream circulating in pipe sections 9A, 9B.

Thus, when ball 3 of the valve is operated to switch the device into the viewing position, the volume of fluid contained in central passage 12 of ball 3 is transferred into viewing chambers 11A and 11B without any pressure conditions variation.

The inert gas filling the viewing chambers is so selected that there is no chemical or physical interaction with the process fluid which it is contacted with. In many petroleum applications, this gas can be nitrogen for example.

### Possible Temperature Control and Maintenance

A temperature increase at constant pressure of the volume of fluid observed can cause the deposits accumulated on the walls or the crystals or particles in suspension therein to melt. Conversely, a temperature decrease at constant pressure can increase the amount of deposits or of particles in suspension in the fluid or modify the state thereof. For the state of the fluid and/or of the walls of the viewing chambers to be really representative of the state of pipes 9A, 9B, it is therefore important that the volume of fluid isolated through the rotation of ball 3 is maintained substantially at the temperature of the circulating fluids.

The device thus preferably comprises a regulation system for controlling the temperature of the isolated volume of fluid in the opposite chambers. This system comprises for example coils 20 wound around lateral viewing sleeves 53, 54 in which circulates a heat carrier whose temperature is controlled by an automatic regulation set 21 associated with a temperature detector 22 in a section of the pipe. Lateral viewing sleeves 53, 54 can also be equipped with a double wall allowing circulation of a heat carrier.

The temperature control system can also be made from heating resistors.

In order to maintain the temperature of the isolated volume of fluid substantially constant, at least viewing chambers 53, 54 can be insulated.

Thermoregulation of the fluid can however remain optional if the viewing times are short enough (less than one minute for example).

### Viewing

The state of the walls of lateral viewing chambers 11A, 11B and of central passage 12 of ball 3, as well as their content isolated from the pipe by swivelling the valve, can be observed through transparent portholes 10. If the natural lighting is insufficient or if the isolated fluids are too opaque to allow examination of the inside of lateral chambers 53, 54, an orientable light source 24 can be placed before one of portholes 10, with a sufficient aperture cone to light the walls. A cold light source is preferably selected so as not to modify the temperature of the content of chambers 11A, 11B.

### Injection Circuit

The device also preferably comprises a circuit 25 communicating with a fluid vessel (not shown) by means of a gate valve V6 and with the inside of one of the lateral viewing chambers (11A for example).

The vessel contains for example additives intended to prevent the formation of deposits or accumulations (anti-hydrate additives for example in oil pipes). Their efficiency can thus be precisely tested under the thermodynamic circulation conditions. The vessel can also contain a suitable additive for cleaning, if need be, viewing chambers 11A, 11B and inner passage 12 of ball 3.

### Measurements

It is also possible to place detection devices, cameras, optical detectors, gamma-meters, etc., before the end walls (not necessarily transparent if the measuring devices used do not work in the visible light radiation spectrum) of observation chambers 11A, 11B in order to measure for example the density of the particles carried by the fluids, possibly connected to measurement acquisition devices.

### Utilization of the Device

The fluid circulates in pipe section 9A, then it flows through ball 3 that is in a circulation position (FIG. 1) prior to flowing out through pipe section 9B.

At fixed time intervals, the valve is swivelled so as to switch into the viewing position (FIG. 2). In this position, passage 12 in ball 3 is substantially in line with the axis of lateral chambers 11A, 11B.

Before switching from the circulation position to the viewing position, valves V1, V2, V3 of pressure balancing circuits 16 and 18 are opened so that the inert gas of accumulator 17 flows into viewing chambers 11A, 11B and that its pressure is that of the fluid in the pipe. The value of the pressure is thus maintained and the structure of the possible deposits on the sleeve, as well as the structure of the solids or of the crystals possibly present in the fluid, is not modified.

After visual observation or recording of images of the deposits and crystals, the fluid trapped in the viewing volume is discharged through discharge line T and bleed valve V5, possibly for further chemical analyses.

This discharge is necessary anyway when the fluid is too opaque to allow normal examination of the deposits on the walls of passage 12 and of lateral chambers 11A, 11B. During discharge, the gas supplied by accumulator 17 is used to maintain the pressure in lateral chambers 11A, 11B. If necessary, the gas reserve in accumulator 17 can be completed.

A filter F can be interposed at the base of lower chamber 11B to prevent passage of crystals into the bleed circuit.

The viewing device according to the invention thus allows to readily observe the formation of hydrates and paraffins that settle on the walls of pipes carrying a petroleum fluid and/or the crystals that are carried by the fluid.

The viewing device according to the invention also allows to readily observe the state of the inner walls of central passage 12 of ball 3 and of lateral chambers 11A and 11B.

The viewing device can also be arranged on a bypass line connected to a main oil production pipe.

1) A viewing device adaptable to a pipe in which fluids containing solid particles circulate, allowing to examine a volume of fluid isolated from the fluid stream without changing the thermodynamic state thereof in relation to that of the circulating fluid, comprising a ball valve (1) provided with a central passage (12), which is interposed between two pipe sections (9A, 9B) and means for swivelling the ball valve between a first position where central passage (12) communicates the two pipe sections (9A, 9B) on either side of valve (1) and a second position where the volume of fluid in central passage (12) is isolated from the pipe and communicates with at least one lateral viewing chamber (53, 54) closed by a transparent porthole (10), characterized in that it comprises balancing means for maintaining said volume of fluid substantially in the same thermodynamic state as the fluids in the pipe, in the second position of ball valve (1).

2) A device as claimed in claim 1, characterized in that the balancing means comprise a pressure balancing set and a device intended for thermoregulation of the fluids in each lateral chamber (53, 54).

3) A device as claimed in claim 2, characterized in that the pressure balancing set comprises at least one circuit (15, 16, 18) associated with control valves (V1, V2, V3, V4), this circuit communicating with a pipe section (9B) and at least one lateral viewing chamber (53, 54) by means of an automatic pressure balancing means, in order to maintain the pipe and said lateral viewing chamber under equipressure.

4) A device as claimed in claim 3, characterized in that the automatic balancing means comprises a membrane accumulator (17) containing an inert gas.

5) A device as claimed in any one of the previous claims, characterized in that the balancing means comprise a temperature regulation system (20-22) for maintaining in each lateral viewing chamber (53, 54) a temperature substantially equal to that prevailing in pipe sections (9A, 9B).

6) A device as claimed in claim 5, characterized in that temperature regulation system (20-22) comprises circuits (20) for circulating a heat carrier around at least one lateral chamber (53, 54).

7) A device as claimed in claim 5, characterized in that the temperature regulation system comprises an electric thermostat-controlled heating circuit.

8) A device as claimed in any one of the previous claims, characterized in that it comprises a ring (14) lining the inner passage in ball (3), made from the same material as the inner walls of pipe sections (9A, 9B).

9) A device as claimed in any one of the previous claims, characterized in that diameter d₁ of the central passage of ball (3) is such that
$$Arcsin ( \frac{{d}_{1}}{D} ) < \frac{π}{n}$$
and preferably less than or equal to
$$\frac{3 π}{4 n}$$
where D is the diameter of the ball and n the number of connecting sleeves (51-54) of the device.

10) A viewing device as claimed in claim 1, characterized in that it comprises at least one fluid discharge circuit comprising a line (T) provided with a bleed valve (V5) connected to at least one lateral viewing chamber (54) for discharging the fluid trapped in ball (3) and each lateral viewing chamber (53, 54).

11) A viewing device as claimed in any one of the previous claims, characterized in that it comprises at least one circuit (25, V6) intended for injection of fluids such as deposition preventing additives or cleaning agents into at least one lateral viewing chamber (11A, 11B).

12) A viewing device as claimed in any one of the previous claims, characterized in that it comprises at least one lighting device (24) for lighting the inside of each lateral viewing chamber (53, 54) and of passage (12).

13) A viewing device as claimed in any one of the previous claims, characterized in that it comprises at least one measuring device arranged before a lateral viewing or observation chamber for measuring physical parameters of the fluids and/or of the particles transported.

14) A device as claimed in any one of the previous claims, characterized in that the ball valve is a four-way ball valve, two ways thereof communicating respectively with pipe sections (9A, 9B) on either side of the body of the ball valve, two other ways forming said two lateral chambers and being delimited by transparent walls.

15) Application of the device as claimed in any one of claims 1 to 14 for viewing paraffin or hydrate deposits in a petroleum fluid.

16) Application of the device as claimed in any one of claims 1 to 14 for viewing the corrosion of pipe walls due to petroleum effluents.

17) Application of the device as claimed in any one of claims 1 to 14 for viewing scale deposits and deposits of other salts in water supply pipes and/or industrial facilities pipes.

18) Application of the device as claimed in any one of claims 1 to 14 for viewing the corrosion of the inner walls of ball (3) lined with a tube section (14) similar to that which constitutes the same industrial facilities pipes.
